(19) United States
(12) Patent Application Publication
(10) Pub. No.: US 2014/0328187 A1
(43) Pub. Date: Nov. 6, 2014

(54) Network Connectivity Management in Wireless Apparatus

(71) Applicants: Tommi Rantanen, Tampere (FI); Mikko Tasa, Tampere (FI); Ville Leva, Tampere (FI); Anssi Niemi, Tampere (FI); Markku Ala-Vannesluoma, Kangasala (FI)

(72) Inventors: Tommi Rantanen, Tampere (FI); Mikko Tasa, Tampere (FI); Ville Leva, Tampere (FI); Anssi Niemi, Tampere (FI); Markku Ala-Vannesluoma, Kangasala (FI)

(73) Assignee: NOKIA CORPORATION, Espoo (FI)

(21) Appl. No.: 14/366,195

(22) PCT Filed: Jan. 2, 2012
(86) PCT No.: PCT/FI2012/050003

§ 371 Date: Jun. 17, 2014

(51) Int. Cl. H04W 24/02

(52) U.S. Cl. CPC H04W 24/02; H04W 24/06
USPC 370/242

(57) ABSTRACT

A method, apparatus, and computer program for managing network connectivity are disclosed. After successfully establishing a radio connection with an access point, a wireless apparatus using the radio connection to access a network beyond the access point is configured to carry out a network connection test. If the network connection test fails, the access point is blacklisted for a determined time period defined by a timer counted in the wireless apparatus.

### FIELD

The invention relates to the field of radio communications and, particularly, to managing network connectivity in a wireless apparatus.

### BACKGROUND

A wireless apparatus may utilize a wireless network to gain access to the Internet and/or other networks. In connection with establishing a network connection, the wireless apparatus establishes a radio connection with the wireless network through an access point, and the network connection is built on top of the radio connection.

### BRIEF DESCRIPTION

According to an aspect of the present invention, there is provided a method as specified in claim 1.

According to another aspect of the present invention, there is provided an apparatus as specified in claim 13.

According to another aspect of the present invention, there is provided an apparatus as specified in claim 26.

According to yet another aspect of the present invention, there is provided a computer program product embodied on a computer readable distribution medium as specified in claim 27.

Embodiments of the invention are defined in the dependent claims.

### LIST OF DRAWINGS

Embodiments of the present invention are described below, by way of example only, with reference to the accompanying drawings, in which

FIG. 1 illustrates a wireless communication scenario to which embodiments of the invention may be applied;

FIG. 2 illustrates a flow diagram of a process for managing network connectivity of a wireless apparatus according to an embodiment of the invention;

FIG. 3 illustrates a process for removing no-connectivity classification of an internet access point detected previously as incapable of providing an internet connection;

FIGS. 4 and 5 illustrate embodiments of architecture of a wireless apparatus according to some embodiments of the invention;

FIGS. 6 to 8 illustrate procedures for managing internet connectivity in the wireless apparatus according to some embodiments of the invention;

FIG. 9 illustrates an embodiment of display contents of the wireless apparatus; and

FIG. 10 is a block diagram of an apparatus according to an embodiment of the invention.

### DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

A general architecture of a wireless communication system to which embodiments of the invention may be applied is illustrated in FIG. 1. FIG. 1 illustrates a wireless apparatus 104 that is capable of selecting an internet access point (IAP) 100, 102 to provide the wireless apparatus with an internet connection. The IAPs 100, 102 may each belong to different wireless networks. In connection with IEEE 802.11 wireless networks, the wireless network may be called a basic service set (BSS). A BSS may be defined by a group of wireless communication devices comprising an access point (AP) and one or more terminal stations (STA) communicating with the access point. A basic service set (BSS) is a basic building block of an IEEE 802.11 wireless local area network (WLAN). The most common BSS type is an infrastructure BSS that includes a single AP together with all associated, non-access-point STAs. The AP may be a fixed AP as APs 100, 102, or it may be a mobile AP. The APs 100, 102 may provide the access to other networks, e.g. the Internet. In another embodiment, at least one of the BSSs is an independent BSS (IBSS) or a mesh BSS (MBSS) without a dedicated AP, e.g. the AP 100 or 102 providing the wireless apparatus 104 with the internet connection may in such an embodiment be a mobile station. While embodiments of the invention are described below in the context of the above-described topologies of IEEE 802.11, it should be appreciated that other embodiments of the invention are applicable to networks based on other specifications, e.g. WiMAX (Worldwide Interoperability for Microwave Access), UMTS LTE (Long-term Evolution for Universal Mobile Telecommunication System), UMTS LTE-Advanced, UMTS Wideband Code Division Multiple Access, High-Speed (Downlink/Uplink) Packet Access, General Packet Radio Service GPRS, and other networks.

The establishment of a radio connection between the wireless apparatus 104 and the AP 100, 102 may include an authentication process in which an identity of the wireless apparatus is established in the AP 100, 102. The authentication may comprise exchanging an encryption key used in the BSS. The wireless apparatus may have established a concurrent authentication with a plurality of IAPs, e.g. with both APs 100, 102. After the authentication, the wireless apparatus 104 may select an AP to provide the wireless apparatus with an internet connection and, as a consequence, it may carry out an association process in which the STA is fully registered in the BSS of the selected IAP 100 or 102, e.g. by providing the wireless apparatus with an association identifier (AID) for frame transmissions. The association may be considered as a physical and medium access control layer (L1/L2) radio connection between the wireless apparatus and the selected AP 100 or 102.

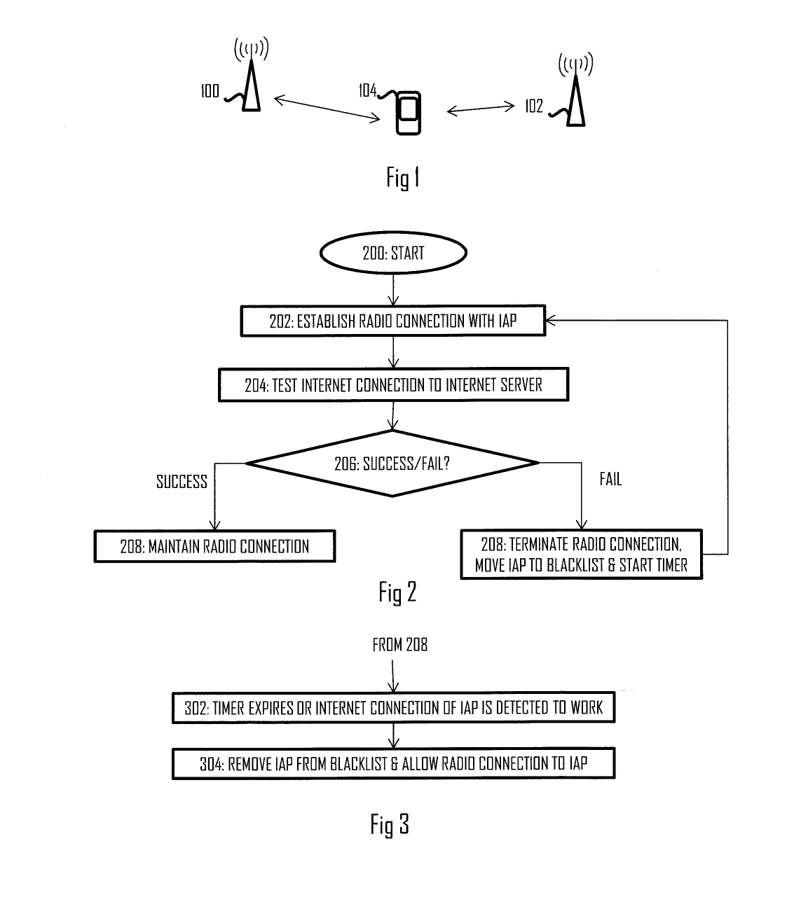

Let us now describe an embodiment for managing network connectivity in the wireless apparatus 104 according to an embodiment of the invention with reference to a flow diagram of FIG. 2. FIG. 2 illustrates an embodiment of a procedure for managing the network connectivity in the wireless apparatus 104 by executing a routine that verifies the network connectivity after a radio connection with a serving access point has been established. The process may be understood to be carried out as a computer program executed by a processor of the wireless apparatus 104. Referring to FIG. 2, the process starts in block 200. The trigger for starting the process may be a request for an network connection, e.g. internet connection, acquired from an application executed in the wireless apparatus 104. In block 202, the wireless apparatus is configured to establish a radio connection with an access point (AP) 100, 102. The establishment of the radio connection may comprise association or any other procedure that prepares the wireless apparatus to carry out frame transmission with the access point 100, 102.

After completing the establishment of the radio connection, a network connection test is carried out in block 204, the network connection test comprising testing whether or not the access point has a working connection with a network server. Block 204 may thus comprise testing higher layer connectivity after the radio connection has been established so as to verify whether or not the connection from the access point towards the network behind the access point is working. Block 204 may comprise connecting to an internet server, e.g. a dedicated server used for testing the internet connectivity, or connecting to a local network server, e.g. an intranet server or a digital living network alliance (DLNA) server. In yet another embodiment, the network connection test tests connectivity to wireless application protocol (WAP) network services. An address, e.g. an internet protocol (IP) address of the server, may be stored in the wireless apparatus. In block 206, the result of the network connection test is evaluated. If the network connection test fails, the process proceeds to block 208 in which the radio connection is terminated and a classification of the access point is changed temporarily into a no-connectivity class indicating that the access point is not capable of providing the network connection. The duration the access point is maintained in the no-connectivity class is timer-based and defined by a timer counted in the wireless apparatus. The process may then return from block 208 to block 202 to attempt the network connection with another access point. On the other hand, if the network connection test is successful, the process proceeds to block 206 in which the radio connection is maintained and the application requesting the network connection may utilize the radio connection.

The embodiments described herein are directed to testing the internet connectivity, but it should be appreciated that other embodiments of the invention are directed to testing network connectivity in other contexts. With respect to the terminology used in the following description, a term “internet access point (IAP)” is used to refer to an access point, e.g. any one of the APs 100, 102. The IAP refers to that the AP is provided with capability to connect to the Internet. However, because of occasional malfunctions, the connection between the Internet and the IAP may fail, and some embodiments of the invention may be used to test the internet connectivity of the IAPs.

On occasion, a serving IAP may temporarily be unable to connect to the Internet for any number of reasons such as network maintenance, failure to obtain an IP address, etc. When a user attempts to use an internet service such as a web browser, and the serving IAP has an internet connectivity problem at the time, the user may be unaware as to internet browsing is not possible, while it was previously working. Some applications inform the user about the failure in the internet connection after a while, e.g. 30 seconds to 1 minute. Some applications do not provide any indication, so the user is puzzled whether the connection or the application itself is malfunctioning. Correcting this problem could conventionally require the user to manually change settings, power off a transceiver of the wireless apparatus, or even delete the known saved IAP via a user interface of the wireless apparatus so that the wireless apparatus could connect to another IAP. The above-described embodiment provides an automated procedure executed in the wireless apparatus 104 that ensures a working internet connection without user intervention, provided that there exists at least one IAP that is able to provide the internet connection.

In an embodiment, the network connection test comprises testing a network connection speed. The network connection speed test may comprise connecting a network server and measuring data rate or another metric representing the network connection speed of the connection with the server. The metrics may include at least one of the following: the data rate, a round-trip-time, a signal strength, a bandwidth, connection access technology, cost, and a provided quality-of-service (QoS) versus QoS requirements of the application. Then the determined network connection speed with a determined speed threshold which defines a minimum requirement for the network connection speed. If the determined network connection speed is less than the speed threshold, the classification of the access point may be changed in the wireless apparatus temporarily into the no-connectivity class. If the determined network connection speed is higher than the speed threshold, the network access and the radio connection may be allowed.

The no-connectivity classification of the IAP may be used in the wireless apparatus to prevent establishment of the radio connection through the IAP at least for the purpose of accessing the Internet. It should be appreciated that the radio connection to the IAP may be allowed for other purposes, e.g. using the IAP in connection with Digital Living Network Alliance (DLNA) or other services provided within the local network. The IAP may be considered as being included in a blacklist associated with IAPs through which the internet connection is not currently allowed because of the problems in the internet connectivity. FIG. 3 illustrates an embodiment of a procedure that may be executed to remove the no-connectivity classification of the IAP in order to allow the internet connection through the IAP. In block 302, it is determined that an event triggering the removal of the no-connectivity classification of the IAP has been detected. As mentioned above, one criterion for removing the no-connectivity classification may be based on the timer counted in the wireless apparatus. Typically, the failure of the internet connectivity between the IAP and the Internet is of permanent or semi-permanent nature. Therefore, in an embodiment the duration counted by the timer is at least one hour. In an embodiment, the duration is two hours. In another embodiment, the duration is over 30 minutes.

In an embodiment, the timer is the only criterion, while in another embodiment at least one other criterion is used. The other criterion may be, for example, detection that the internet connectivity of the IAP has been restored before the expiry of the timer. For example, upon an application executed in the wireless apparatus requests an internet connection through a specific IAP currently having the no-connectivity classification, the wireless apparatus may reiterate the internet connection test for the requested IAP after the establishment of the radio connection with the requested IAP has been completed. If the internet connection test is successful, the classification of the IAP may be changed from the no-connectivity class to another class that indicates the availability of the internet access. On the other hand, if the internet connection test is again failed, the no-connectivity classification of the internet access point may be maintained. In an embodiment, the counter is reset at this stage to start the counting from the start, while in another embodiment the counter is configured to proceed from its current reading unaffected. Another criterion uses a second timer to count the time for retesting the internet connectivity of all or a subset of blacklisted IAPs. IAPs now providing a working internet connection may be removed from the blacklist. Yet another criterion carries out the internet connection test upon triggered by an event in the operation of the wireless apparatus, e.g. when a screen saver is turned off, when the wireless apparatus is idle (not used by a user) or has been idle for a determined period of time, and/or carrying out an internet connection test for any WLAN IAP before establishing a connection through a cellular communication system (e.g. UMTS) so as to detect available WLAN IAPs. In another embodiment, the internet connection test for any WLAN IAP is carried out during the establishment of the cellular connection or immediately after the cellular connection has been established in order not to delay the establishment of the cellular connection.

In block 304, after fulfilling the criterion for allowing the retrial of the internet connection through the IAP in block 302 the no-connectivity classification of the IAP is removed in block 304. This may comprise changing the classification of the IAP into an access-allowed class or to any other class that allows the trial of the internet connection through the IAP. As a consequence, the removal of the IAP from the blacklist is also an automated process which allows the automated selection of the internet connection through the IAP after the allowance of the internet connectivity. This further improves the user experience.

As mentioned above, the internet connection test verifies the internet connection that utilizes the radio connection. As a connection, the internet connection may be tested on a higher protocol layer than the layer of the radio connection. In an embodiment, the internet connection test is realized on a layer higher than a Medium Access Control (MAC) layer (Layer 2) to test whether or not the internet connection works on top of the radio connection. The internet connection test may be realized on a network layer (Layer 3) or a transport layer (Layer 4), for example.

The wireless apparatus 104 may make the classification in association with IAPs, as described above. From another point of view, the wireless apparatus may see an internet connection through a set of settings that realize the internet connection. From this point of view, the classification may be directed to the set of settings, and the set of settings may include the selection of an IAP. As a consequence, upon failing the internet connection test with one set of settings that set of settings may be classified into the no-connectivity class in the above-described manner.

In an embodiment, the decision of classifying an IAP into the no-connectivity class is made for each IAP independently. For example, after failing the internet connection test of a given IAP only one IAP, the tested IAP, is classified into the no-connectivity class. Naturally, a plurality of IAPs may have the no-connectivity classification upon failing the internet connection test individually. Another embodiment relates to wireless networks where multiple IAPs form a single wireless network, e.g. a service set. In connection with IEEE 802.11 networks, such IAPs may share the same service set identifier (SSID). In this embodiment, upon one IAP of such a wireless network fails the internet connection test, all the IAPs of the same wireless network, e.g. the IAPs sharing the same SSID, security parameters, and network mode are classified into the no-connectivity class. Accordingly, the wireless apparatus may categorize a plurality of inter-related IAPs into the no-connectivity class upon failing the internet connection test in connection with one of the inter-related IAPs.

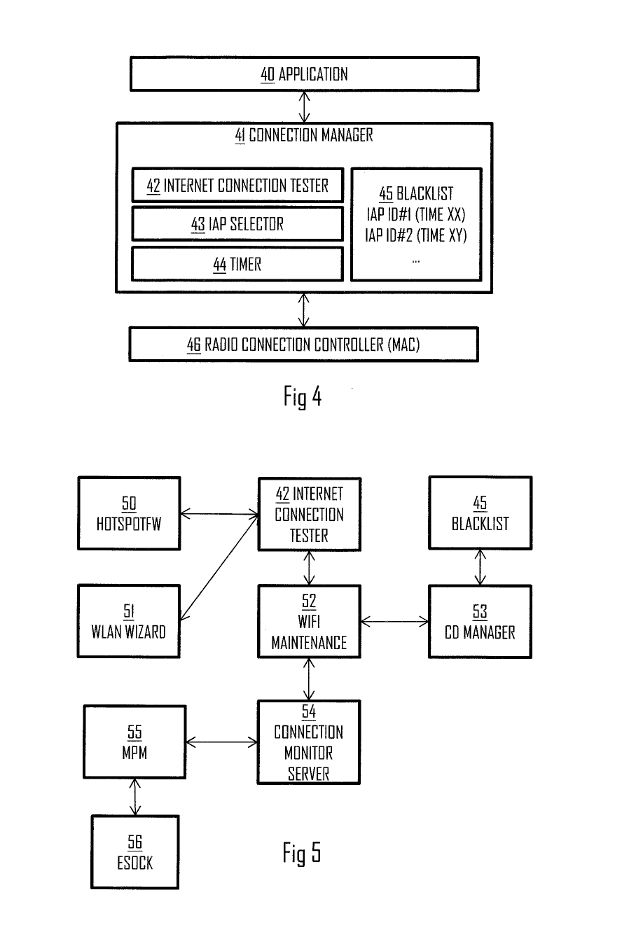

FIGS. 4 and 5 illustrate some embodiments of the architecture of the wireless apparatus 104 in view of the present invention. FIG. 4 is a general level diagram showing elements related to the management of the internet connectivity, while FIG. 5 illustrates functional entities of the wireless apparatus in detail in an embodiment where the wireless apparatus 104 is a WLAN apparatus. Referring to FIG. 4, the wireless apparatus comprises at least one application 40 which may be a computer program application executed in the wireless apparatus and at least occasionally needing an internet connection, e.g. an e-mail client, a messaging application, a game, an internet browser, a voice over IP (VoIP) application, etc. Upon launching the application 40 and triggering the establishment of the internet connection in the application 40, the application 40 may output a request for establishing the internet connection to a connection manager 41 handling internet connections in the wireless apparatus. The interface between the application 40 and the connection manager 41 may be realized through a middleware routine, for example.

The connection manager 41 may comprise as sub-units an IAP selector 43 configured to select an IAP to provide a radio connection for the internet connection, an internet connection tester 42 configured to verify the internet connection in the above-described manner after the radio connection to the selected IAP has been established, and a timer 44 counting a quarantine time for the blacklisted IAPs. The connection manager 41 may also store the blacklist 45 listing the IAPs classified into the no-connectivity class. Depending on the embodiment, the timer 44 may count the time separately for each blacklisted IAP, or the counter 44 may count absolute time, and the connection manager may have stored in the blacklist a time instant when each IAP was added to the blacklist and/or a time instant when each IAP shall be removed from the blacklist, wherein each time instant is linked to the absolute time of the timer 44.

Upon receiving the request for the establishment of the internet connection from the application 40, the connection manager 41 may activate the IAP selector 43 to select an IAP for the internet connection. Upon selecting the IAP, the connection manager 41 may inform a radio connection controller 46 about the selected IAP, and the radio connection controller establishes the radio connection with the selected IAP. After the radio connection has been established, e.g. the L2 connection, is ready the radio connection controller may notify the connection manager about the readiness of the radio connection. Then, the connection manager may activate the internet connection tester 42 to test the internet connection to an internet server. The test may be as simple as a “ping” or a request-response type of query to an internet server. If the internet connection is verified to be successful, the connection manager 41 may maintain the radio connection. On the other hand, if the internet connection test fails, the connection manager may put the selected IAP into the blacklist for the determined period of time and instruct the IAP selector to select another IAP. In this manner, the procedure may continue until the verified internet connection is achieved or the IAP selector runs out of possible IAPs.

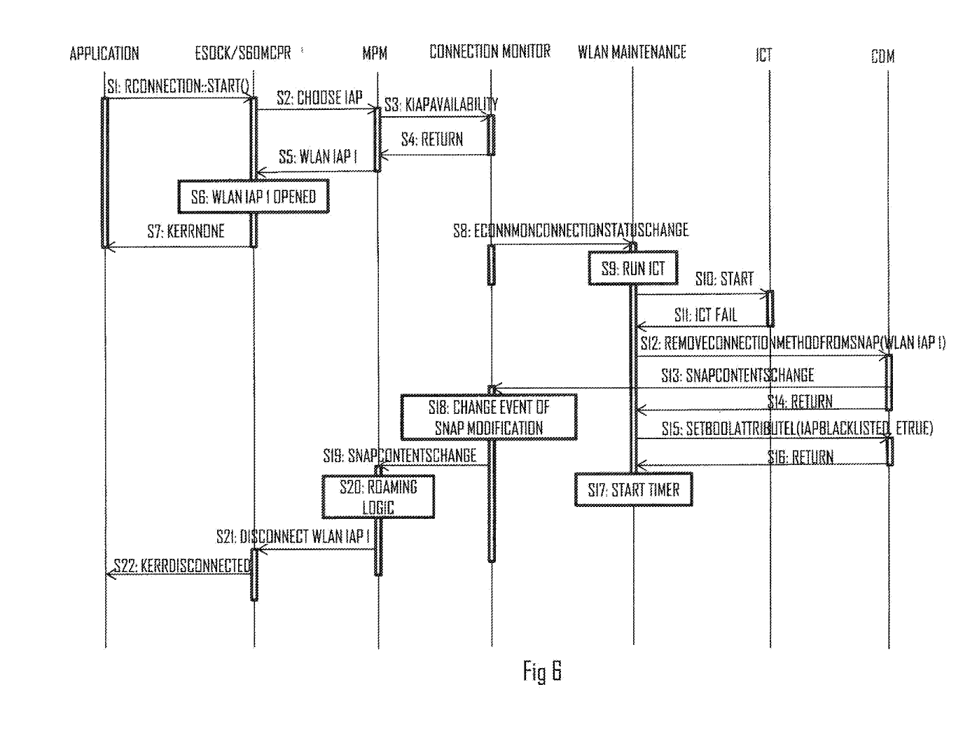

Now, let us consider an embodiment of the structural entities of the wireless apparatus with reference to FIG. 5 and embodiments for realizing the blacklisting and unblacklisting an IAP with reference to signalling diagrams of FIGS. 6 to 8. FIGS. 5 to 8 relate to an embodiment where the wireless apparatus utilizes a Symbian operating system, e.g. some of the commands illustrated in FIGS. 6 to 8 are Symbian functions, but a skilled person is capable of applying the same principles and functions in other operating systems on the basis of this description and common general knowledge.

FIG. 5 illustrates an embodiment of the connection manager 41 comprising the internet connection tester 42 and the blacklist 45. The blacklist may be understood as metadata associated with each IAP and indicating the classification of the IAPs. A connection database (CD) manager handles the classification of the IAPs by changing the metadata of the IAPs upon detecting the failed internet connectivity with an IAP or upon removing the IAP from the blacklist, e.g. upon the quarantine period has expired. In an embodiment, upon expiry of the quarantine period the internet connectivity test is repeated so as to determine whether the blacklisting should be removed or maintained.

The wireless apparatus 104 may identify those IAPs that are able to provide the internet connection as a list, e.g. a service network access point (SNAP) list, and the CD manager 53 may exclude any blacklisted IAP from the SNAP list and then reinstate the IAP back to the SNAP list upon expiry of the timer. The operation of the CD manager 53 may be controlled by a WLAN maintenance unit 52 configured to call the internet connection tester 42, when required, and upon detecting a need to change a classification of an IAP, to configure the CD manager 53 to carry out the change in the classification of the IAP. The WLAN maintenance unit 52 may also communicate with a connection monitor server 54 configured to monitor the operation of the connections. The connection monitor server 54 may monitor the operation of the radio connections in the wireless apparatus and provide information when the radio connection is ready for the internet connectivity test, for example.

A socket server (ESOCK) module 56 may provide a communication link between the connection manager 41 and the application 40 or a part of the application, e.g. an Application-Level Roaming (ALR) client. The ESOCK module 56 may instruct a Mobility Policy Manager (MPM) to select the WLAN (radio) connection according to a determined criterion. The MPM 55 may realize at least some of the functionalities of the IAP selector 43, and it may utilize the SNAP list in the selection of the IAP. The MPM 55 may return a selection result to the ESOCK module 56, and the ESOCK module 56 may then manage the establishment of the radio connection with the selected IAP and report information on the successful radio connection to the application.

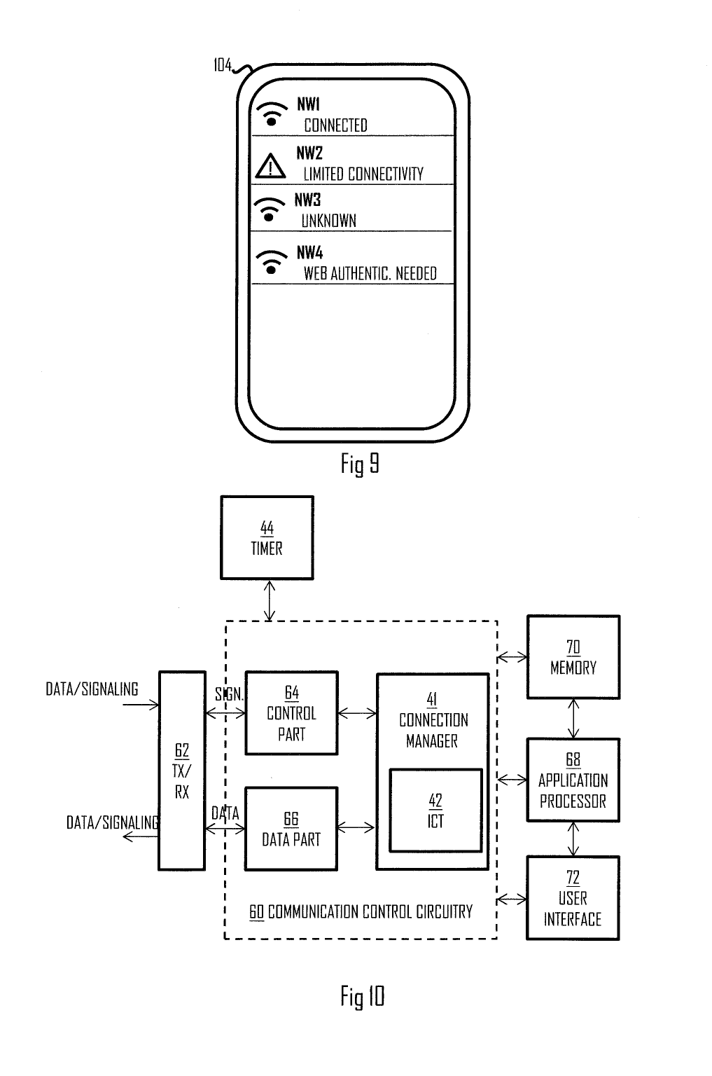

A hotspot framework (HotspotFW) 50 may mark any hotspot WLAN internet access points that have a web authentication using captive portal, for example, and it may utilize the internet connection tester 42 to test the internet connections provided by the hotspot IAPs. In an embodiment, the HotspotFW 50 is configured not to delete a hotspot IAP from a hotspot list of IAPs upon failing an internet connection test. The IAP may also be maintained in the hotspot list whether or not the user has logged in with his/her credentials via web authentication, e.g. the captive portal using the hotspot IAP. A WLAN wizard 51 may be responsible for handling user interaction in connection with the WLAN connections. The WLAN wizard 51 may, for example, control display contents provided to the user through a display of the wireless apparatus. Some embodiments related to the functionality of the WLAN wizard 51 are described in connection with FIG. 9.

Let us now consider interaction between the modules of FIG. 5 in greater detail. FIG. 6 illustrates a flow diagram of an embodiment for realizing the establishment of the internet connection according to an embodiment of the invention. In this case, the internet connection is tested and detected to fail. Referring to FIG. 6, an application requests for an internet connection from the ESOCK module 56 in S1. In S2, the ESOCK module 56 instructs the MPM 55 to select an IAP that shall provide the radio connection. In S3, the MPM 55 queries for available IAPs from the connection monitor server 54, and the connection monitor server 54 checks for available IAPs and provides identifiers of the available IAPs in a response in S4. Then, the MPM selects one of the available IAPs, e.g. IAP 1, and reports the selected IAP to the ESOCK module in S5. Then, the ESOCK module 56 establishes a radio connection with IAP 1, and the radio connection with the IAP 1 is considered to be opened (S6). In S7, the ESOCK module 56 reports to the application and, optionally to the connection monitor server that the request 1 was completed without errors.

Upon detecting the opened radio connection with the IAP 1, the connection monitor server 54 indicates in S8 the change in the connection status of the wireless apparatus 104 to the WLAN maintenance unit 52. In response to the reception of the notification, the WLAN maintenance unit 52 calls the internet connection tester (ICT) 42 to execute the internet connection test (S10). Let us now assume that the internet connection with the internet server fails, and the ICT reports the failure to the WLAN maintenance unit in S11. Upon receiving the notification about the failure in the internet connection test, the WLAN maintenance unit 52 may command the CD manager (CDM) to remove the IAP 1 from the SNAP list (S12). The CDM may then carry out a procedure for removing the IAP 1 from the SNAP list and inform the connection monitor server 54 about the change in the SNAP contents (S13). A return of the function is indicated by S14. In S15, the WLAN maintenance unit 52 may instruct the CDM to change the classification of the IAP 1 into the no-connectivity class. The instruction may comprise adding to the IAP 1 meta data that indicates that the IAP 1 is in the blacklist. The CDM may implement the change in the classification of the IAP 1, and the procedure may return in S16. In response to returning of S16, the WLAN maintenance unit 52 may start the timer (S17).

Upon receiving the information on the change of the SNAP contents, the connection monitor server 54 may then implement the actual modification of the SNAP contents and start the procedure of terminating the radio connection with the IAP 1 (S18). The connection monitor server 54 may inform the MPM about the change in the SNAP contents (S19), and the MPM may then start a procedure for disconnecting from the IAP 1 and selecting another IAP through IAP selection logic (S20). Upon disconnecting from the IAP 1, the MPM may instruct the ESOCK module 56 to disconnect from the IAP 1 (S21), and the ESOCK module 56 may carry out the disconnection of the radio connection and report an error in the radio connection to the application in S22. Thereafter, the MPM may select another IAP, and the procedure may proceed in a similar manner for the subsequent IAP. If the ICT 42 detects a successful internet connection after receiving the command of S10, it may report about the successful ICT in S11, and the procedure may then end.

In an embodiment, the application and the ICT use the internet connection simultaneously. In this embodiment, the application may be allowed to use the internet connection before it has been verified to operate, e.g. immediately after S7. In another embodiment, the application is allowed to use the internet connection only after the ICT has tested that the internet connection is working.

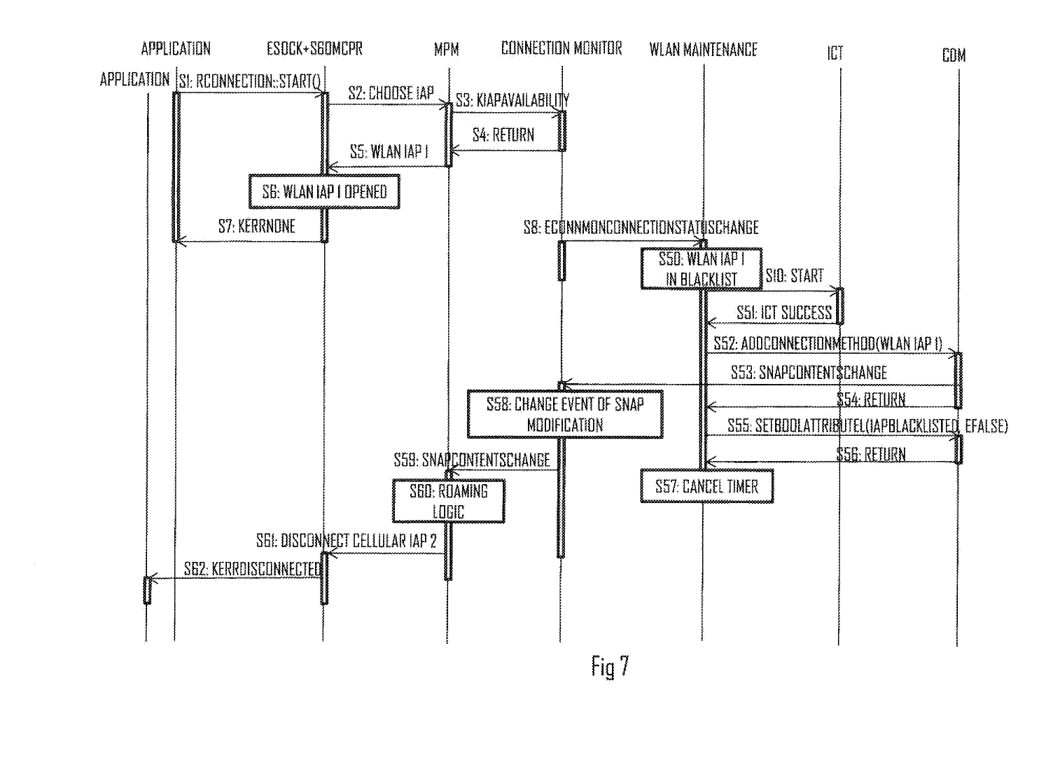

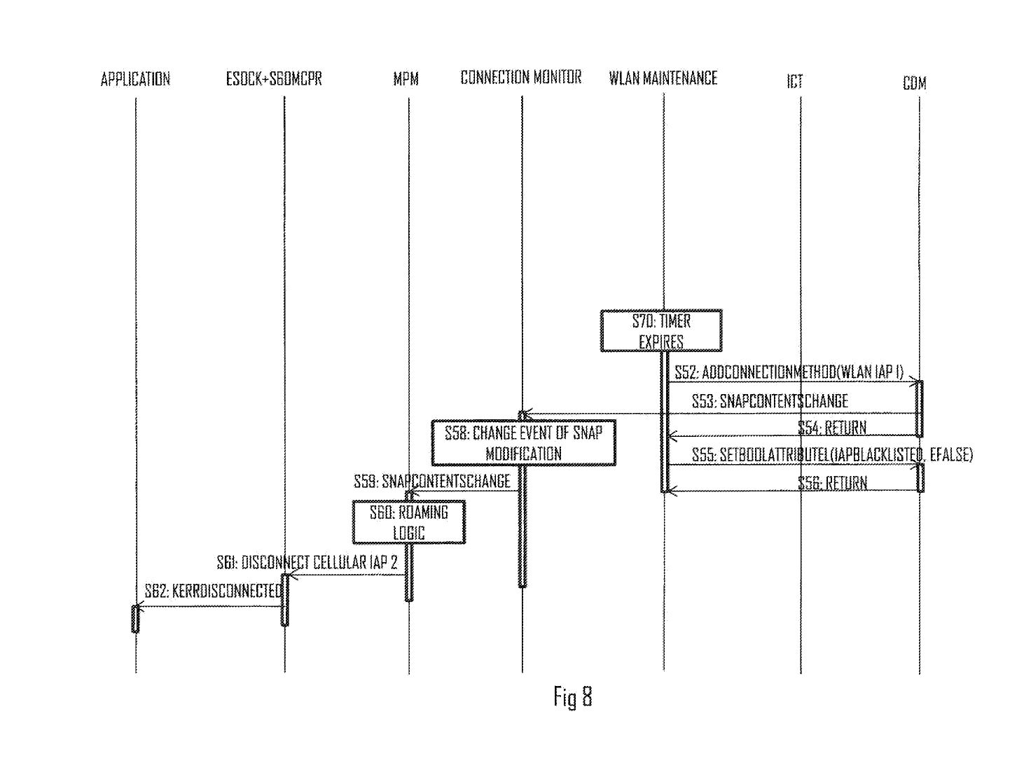

FIGS. 7 and 8 illustrate embodiments for removing the IAP from the blacklist. FIG. 7 illustrates an embodiment where the removal is realized after an application requesting for an internet connection specifically through the IAP 1. Therefore, let us now assume an initial condition that the IAP 1 is in the blacklist and that the MPM has realized the internet connection through another IAP for an application, e.g. a cellular base station through a cellular IAP 2. Steps having the same reference signs as in FIG. 6 represent the same functions. Upon detecting that the radio connection with the IAP 1 has been opened once again and that the IAP 1 is in the blacklist (S50), the WLAN maintenance unit carries out the internet connection test. Now, the ICT detects that the internet connection through the IAP 1 is available, and informs the WLAN maintenance unit 52 about the successful internet connection test in S51. In S52, the WLAN maintenance unit 52 instructs the CDM to add the IAP 1 back to the SNAP list. As a consequence, the CDM reports the connection monitor server about the change in the SNAP contents (S53) and returns the process to the WLAN maintenance unit (S54). Thereafter, the WLAN maintenance unit 52 instructs the CDM to remove the IAP 1 from the blacklist (S55), and the CDM changes the classification of the IAP 1 back to the classification which allows the connection to the IAP 1. Then, the process may return (S56). Upon removing the IAP 1 from the blacklist, the WLAN maintenance unit may cancel the timer 57 with respect to the IAP 1 (S57).

Upon receiving the report about the change of SNAP contents, the connection monitor server 54 may process the change in the SNAP contents (S58) and report the change in the SNAP contents to the MPM 55 (S59). Upon detecting the availability of the IAP 1, the MPM may initiate roaming logic to transfer any on-going internet connection to utilize the radio connection through the IAP 1 (S60). As a consequence, the MPM 55 may disconnect the cellular IAP 2 and inform the disconnection to the ESOCK module 56 (S61). The ESOCK module 56 may then forward the disconnection to an application utilizing the cellular connection (S62), and the connection may be transferred to the connection through the IAP 1.

The embodiment of FIG. 8 is procedurally similar to that of FIG. 7 except for that step S52 is triggered by the expiry of the timer in S70. Upon expiry of the timer, the WLAN maintenance unit 52 triggers the reinstatement of the IAP 1 in the SNAP list (S52) and the removal of the IAP 1 from the blacklist (S55). Additionally, the MPM 55 may select and initiate establishment of the radio connection through the IAP 1 before it causes the disconnection from the cellular IAP 2 (not shown).

FIG. 9 illustrates an embodiment of display contents displayed to the user through a user interface of the wireless apparatus in connection with the internet connectivity management according to an embodiment of the invention. FIG. 9 illustrates a list of wireless networks detected by the wireless apparatus 104. The display contents of the list may be controlled by the WLAN wizard 51 or another entity of the wireless apparatus 104. In an embodiment, there is provided in connection with each IAP known to the wireless apparatus 104, unique display content in a display of the wireless apparatus 104 for the following situations: successful radio connection and successful internet connection; and successful radio connection and failed internet connection. There may be unique display content for other situations as well, as described below. These unique display contents may be displayed in the list illustrated in FIG. 9, or they may be displayed in another manner, e.g. in a pop-up notification window. Let us now describe the unique display contents in greater detail with respect to the embodiment of FIG. 9. Referring to FIG. 9, the wireless apparatus 104 provides in its display unit information on a first wireless network NW1 to which the wireless apparatus 104 is currently connected. The display contents related to the first wireless network NW1 may comprise a unique icon showing that the wireless apparatus is currently connected to the first wireless network NW1, e.g. with a bright colour of the icon, and/or the signal strength of the first wireless network, e.g. with the number of arches in the icon. The display contents related to the first wireless network NW1 may further comprise in a textual form the identity of the first wireless network NW1 and the connectivity class. In this case, the connectivity class is “connected”. In this example, the unique content specifying the successful radio connection and the successful internet connection is the word “connected” displayed. The word “connected” may be displayed after establishing the radio connection with the wireless network NW1 and after successful result in the internet connection test.

The wireless apparatus 104 provides in its display unit also information on other wireless networks it has detected. With respect to a second wireless network NW2, the display contents may comprise a unique display content showing that the second wireless network has the no-connectivity classification to indicate that the second wireless network is able to provide a radio connection but not a working internet connection. The unique display contents representing the no-connectivity classification may comprise an icon showing a problem, e.g. an error triangle illustrated in FIG. 9 and/or textual contents showing the classification, e.g. “limited connectivity” as in FIG. 9. In this example, the unique content specifying the successful radio connection and the failed internet connection is the text “limited connectivity” and the icon displayed in the display unit. The unique display content may be displayed after establishing the radio connection with the wireless network NW1 and after failed result in the internet connection test.

With respect to a third wireless network NW3, this network may have been detected by the wireless apparatus, but the wireless apparatus has not established any connection with the network NW3. As a consequence, the wireless apparatus may show in textual form that it has no knowledge of the internet connectivity of the wireless network NW3, e.g. with word “unknown”. The icon on the left hand side may be displayed as dimmed to represent that the wireless apparatus 104 has no connection with the network NW3, and the signal strength associated with the network NW3 may be shown with the number of arches.

Another example of the unique display content may be display contents that show that the IAP is able to provide the internet connectivity but a web authentication is needed to gain access to the Internet. For example, a hotspot IAP may require a web authentication. With respect to a fourth wireless network NW4, let us assume that the fourth wireless network is operated by a hotspot IAP, and that the wireless apparatus 104 has detected the fourth wireless network NW4 as the hotspot or, in other words, as an IAP using captive portal, for example. Upon detecting the wireless network NW4 in the list of hotspots, the display contents associated with the wireless network NW4 may show the need for the internet authentication in a textual form, e.g. text “web authentication needed”. This expands the number of unique display contents associated with the different wireless networks by providing two states as combined with those listed above: web authentication needed and web authentication not necessary.

FIG. 10 illustrates an embodiment of an apparatus comprising means for carrying out the above-mentioned functionalities of the wireless apparatus 104 configured to manage internet connectivity through a wireless network. The apparatus may be a wireless apparatus of an IEEE 802.11 network or another wireless network. The apparatus may be a mobile or portable wireless apparatus. The apparatus may be a computer (PC), a laptop, a tablet computer, a cellular phone, a palm computer, or any other apparatus provided with radio communication capability. In another embodiment, the apparatus is comprised in such a wireless apparatus, e.g. the apparatus may comprise a physical circuitry, e.g. a chip, a processor, a micro controller, or a combination of such circuitries in the wireless apparatus.

The apparatus may comprise a communication controller circuitry 60 configured to control the communications in the wireless apparatus and the management of the connectivity. The communication controller circuitry 60 may comprise a control part 64 handling control signalling communication with respect to transmission, reception, and extraction of control or management frames including establishing radio connections and terminating the radio connections, as described above. The communication controller circuitry 60 may further comprise a data part 66 that handles transmission and reception of payload data during transmission opportunities of the wireless apparatus (transmission) or transmission opportunities of other wireless apparatuses (reception). The communication controller circuitry 50 may further comprise the above-described connection manager 41 comprising the internet connection tester 42. The connection manager may instruct the control part 64 to establish the radio connection with a selected IAP and, upon receiving a notification of the completed radio connection establishment, the connection manager 41 may call the internet connection tester 42 to test the internet connectivity. The internet connection tester may 42 instruct the data part 66 to transmit a higher layer packet to an internet server so as to test the internet connection. On the basis of whether or not the internet connection tester receives a response from the internet server through the data part 66, the internet connection tester 42 reports the results of the test to the connection manager 41, and the connection manager 41 may select a new IAP, if necessary.

The apparatus may further comprise an application processor circuitry 68 configured to execute applications in the apparatus. The application processor circuitry 68 may be configured to communicate with the communication control circuitry with respect to providing the applications with an internet connection. The apparatus may further comprise the timer 44. In the communication control circuitry 60 or in communication with the communication control circuitry 60 (as shown in FIG. 10).

The circuitries 41 and 64 to 68 may be carried out by the one or more physical circuitries or processors. In practice, the different circuitries may be realized by different computer program modules. Depending on the specifications and the design of the apparatus, the apparatus may comprise some of the circuitries 41 and 64 to 68 or all of them.

The apparatus may further comprise a memory 70 to store computer programs (software) configuring the apparatus to perform the above-described functionalities of the wireless apparatus managing the internet connectivity. The memory 70 may also store communication parameters and other information needed for the wireless communications, e.g. the rules for blacklisting IAPs and for removing the IAPs from the blacklist. The apparatus may further comprise radio interface components 62 providing the apparatus with radio communication capabilities IAPs. The radio interface components 62 may comprise standard well-known components such as amplifier, filter, frequency-converter, (de)modulator, and encoder/decoder circuitries and one or more antennas. The apparatus may further comprise a user interface 72 enabling interaction with the user of the wireless apparatus. The user interface 72 may comprise a display, a keypad or a keyboard, a loudspeaker, etc. The internet connectivity may be shown in the user interface, as described above.

In an embodiment, the apparatus carrying out the embodiments of the invention in the wireless apparatus 104 comprises at least one processor and at least one memory including a computer program code, wherein the at least one memory and the computer program code are configured, with the at least one processor, to cause the apparatus to carry out the functionality of the wireless apparatus 104 in any one of the processes of FIGS. 2 to 9. Accordingly, the at least one processor, the memory, and the computer program code form processing means for carrying out embodiments of the present invention in the apparatus comprised in the wireless apparatus 104.

As used in this application, the term ‘circuitry’ refers to all of the following: (a) hardware-only circuit implementations such as implementations in only analog and/or digital circuitry; (b) combinations of circuits and software and/or firmware, such as (as applicable): (i) a combination of processor(s) or processor cores; or (ii) portions of processor(s)/software including digital signal processor(s), software, and at least one memory that work together to cause an apparatus to perform specific functions; and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term “circuitry” would also cover an implementation of merely a processor (or multiple processors) or portion of a processor, e.g. one core of a multi-core processor, and its (or their) accompanying software and/or firmware. The term “circuitry” would also cover, for example and if applicable to the particular element, a baseband integrated circuit or applications processor integrated circuit (ASIC) for the apparatus according to an embodiment of the invention.

The processes or methods described in FIGS. 2 to 9 may also be carried out in the form of a computer process defined by a computer program. The computer program may be in source code form, object code form, or in some intermediate form, and it may be stored in some sort of carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units.

The present invention is applicable to a wireless apparatus of any one of the wireless communication systems defined above or another suitable wireless communication system. The protocols used, the specifications of wireless communication systems, their network elements and subscriber terminals, develop rapidly. Such development may require extra changes to the described embodiments. Therefore, all words and expressions should be interpreted broadly and they are intended to illustrate, not to restrict, the embodiment. It will be obvious to a person skilled in the art that, as technology advances, the inventive concept can be implemented in various ways. The invention and its embodiments are not limited to the examples described above but may vary within the scope of the claims.

1. A method comprising:
causing a wireless apparatus to establish a radio connection with an access point;
after completing the establishment of the radio connection, carrying out a network connection test in the wireless apparatus, the network connection test comprising testing whether or not the access point has a working connection with a network server and, if the network connection test fails, terminating the radio connection and changing a classification of the access point in the wireless apparatus temporarily into a no-connectivity class indicating that the access point is not capable of providing a network connection, wherein a duration the access point is maintained in the no-connectivity class is defined by a timer counted in the wireless apparatus.

2. The method of claim 1, further comprising: upon expiry of the timer, changing the classification of the access point into a class other than the no-connectivity class and allowing reestablishment of the radio connection to the access point.

3. The method of claim 1, wherein the network connection test operates on a higher layer than a medium access control layer.

4. The method of claim 1, wherein the access point belongs to a wireless network of a plurality of access points, the method further comprising: changing the classification of the wireless network into the no-connectivity class.

5. The method of claim 1, wherein the access point belongs to a wireless network of access points, the method further comprising: changing the classification of an access point of the wireless network into the no-connectivity class only if the network connection test directed to the access point itself fails.

6. The method of claim 1, wherein a time period counted by the timer is at least one hour.

7. (canceled)

8. The method of claim 1, further comprising:
upon an application executed in the wireless apparatus requesting a radio connection with an access point currently having the no-connectivity classification, reiterating the network connection test for the requested access point after the establishment of the radio connection has been completed;
if the network connection test is successful, changing the classification of the access point into a class other than the no-connectivity class; and
if the network connection test is failed, maintaining the classification of the access point.

9. (canceled)

10. The method of claim 1, further comprising: providing, in connection with each access point known to the wireless apparatus, unique display content in a display of the wireless apparatus for the following situations: successful radio connection and network connection; and successful radio connection and failed network connection.

11. The method of claim 1, wherein the network connection test is arranged to test a connection to at least one of the following: the internet, an intranet, a digital living network alliance server, wireless application protocol network services.

12. The method of claim 1, wherein the network connection test comprises testing network connection speed, the method further comprising:
comparing the determined network connection speed with a determined speed threshold; and
if the determined network connection speed is less than the speed threshold, changing the classification of the access point in the wireless apparatus temporarily into the no-connectivity class.

13. An apparatus comprising:
at least one processor; and
at least one memory including computer program code, wherein the at least one memory and the computer program code are configured, with the at least one processor, to cause the apparatus to:
cause a wireless apparatus to establish a radio connection with an access point;
after the establishment of the radio connection has been completed, carry out a network connection test in the wireless apparatus, in which network connection test the apparatus is configured to test whether or not the access point has a working connection with a network server and, if the network connection test fails, to terminate the radio connection and change a classification of the access point in the wireless apparatus temporarily into a no-connectivity class indicating that the access point is not capable of providing a network connection, wherein a duration the access point is maintained in the no-connectivity class is defined by a timer counted in the wireless apparatus.

14. The apparatus of claim 13, wherein the at least one memory and the computer program code are configured, with the at least one processor, to cause the apparatus to, upon expiry of the timer, change the classification of the access point into a class other than the no-connectivity class and allow reestablishment of the radio connection to the access point.

15. The apparatus of claim 13, wherein the at least one memory and the computer program code are configured, with the at least one processor, to cause the apparatus to carry out the network connection test on a higher layer than a medium access control layer.

16. The apparatus of claim 13, wherein the access point belongs to a wireless network of a plurality of access points, and wherein the at least one memory and the computer program code are configured, with the at least one processor, to cause the apparatus to change the classification of the wireless network into the no-connectivity class.

17. The apparatus of claim 13, wherein the access point belongs to a wireless network of access points, and wherein the at least one memory and the computer program code are configured, with the at least one processor, to cause the apparatus to change the classification of an access point of the wireless network into the no-connectivity class only if the network connection test directed to the access point itself fails.

18. The apparatus of claim 13, wherein a time period counted by the timer is at least one hour.

19. (canceled)

20. The apparatus of claim 13, wherein the at least one memory and the computer program code are configured, with the at least one processor, to cause the apparatus to:
upon an application executed in the wireless apparatus requesting a radio connection with an access point currently having the no-connectivity classification, reiterate the network connection test for the requested access point after the establishment of the radio connection has been completed;
if the network connection test is successful, change the classification of the access point into a class other than the no-connectivity class; and
if the network connection test is failed, maintain the classification of the access point.

21. (canceled)

22. The apparatus of claim 13, wherein the at least one memory and the computer program code are configured, with the at least one processor, to cause the apparatus to provide, in connection with each access point known to the wireless apparatus, unique display content in a display of the wireless apparatus for the following situations: successful radio connection and network connection; and successful radio connection and failed network connection.

23. The apparatus of claim 13, wherein the at least one memory and the computer program code are configured, with the at least one processor, to cause the apparatus to test during the network connection test a connection to at least one of the following: the internet, an intranet, a digital living network alliance server, wireless application protocol network services.

24. The apparatus of claim 13, wherein the at least one memory and the computer program code are configured, with the at least one processor, to cause the apparatus to:
test network connection speed during the network connection test;
compare the determined network connection speed with a determined speed threshold; and
if the determined network connection speed is less than the speed threshold, change the classification of the access point in the wireless apparatus temporarily into the no-connectivity class.

25-27. (canceled)
